(19) United States
(12) Patent Application Publication
(10) Pub. No.: US 2022/0189101 A1
(43) Pub. Date: Jun. 16, 2022

(54) THREE-DIMENSIONAL OBJECT MARKING

(71) Applicant: Hewlett-Packard Development Company, L.P., Spring, TX (US)

(72) Inventors: Robert Ulichney, Stow, MA (US); Matthew D. Gaubatz, Seattle, WA (US)

(73) Assignee: Hewlett-Packard Development Company, L.P., Spring, TX (US)

(21) Appl. No.: 17/415,138

(22) PCT Filed: Aug. 16, 2019
(86) PCT No.: PCT/US2019/046804

§ 371 Date: Jun. 17, 2021

(51) Int. Cl. G06T 15/08; G06T 15/04; G06K 7/14; G06K 19/06; B41M 3/14; B42D 25/30; B29C 64/386

(52) U.S. Cl. CPC G06T 15/08; G06T 15/04; G06K 7/1413; B33Y 50/00; B41M 3/14; B42D 25/30; B29C 64/386; G06K 19/06028

(57) ABSTRACT

Examples of methods for three-dimensional object marking are described herein. In some examples, a method may include determining a set of volumes based on a one-dimensional (1D) barcode. In some examples, the method may include overlapping the set of volumes with a voxel representation of a three-dimensional (3D) object. In some examples, the method may include marking voxels of the 3D object that are within the set of volumes.

### BACKGROUND

Items may be labeled. For example, items may be labeled to convey information about the items. Some items may be labeled with text, characters, or symbols. For instance, labeling may be utilized to inform a person about an item, such as materials in clothing, washing directions for clothing, nutrition information for food products, prices of goods, warning labels for machinery, usage directions for pharmaceutical products, etc. In some cases, labeling may be utilized for tracking items (e.g., items for inventory tracking or purchase) or for automated procedures (e.g., detection, sorting, quality control, etc.).

### BRIEF DESCRIPTION OF THE DRAWINGS

FIG. 1 is a flow diagram illustrating an example of a method for three-dimensional (3D) object marking;

FIG. 2 is a flow diagram illustrating an example of a method for 3D object marking;

FIG. 3 is a block diagram of an example of an apparatus that may be used in 3D object marking;

FIG. 4 is a block diagram illustrating an example of a computer-readable medium for 3D object marking;

FIG. 5 is a diagram illustrating an example of a 1D barcode and an example of a set of volumes based on the 1D barcode in accordance with some examples of the techniques described herein; and

FIG. 6 is a diagram illustrating a set of volumes and a 3D object.

### DETAILED DESCRIPTION

Some examples of the techniques described herein are related to barcodes. A barcode is an optical representation of information or data. A one-dimensional (1D) barcode is a barcode where information or data is represented in one dimension of the barcode. In some examples, 1D barcodes may include a set of parallel bars. A bar is a mark. For example, a bar may be a rectangular mark that is distanced from another bar. In some examples, bars may be marks of a first color (e.g., black or another color) and regions between bars may have a second color (e.g., white or another color). In some examples, the information or data of a barcode may be represented by the width(s) of the bars and/or distances between the bars. In some examples, a bar or bars of the 1D barcode may have no height, a nominal height (e.g., 1 pixel), or another height.

1D barcodes may be used in printing, labeling, and/or packaging. For example, some 1D barcodes may provide a representation of data as a visually recognizable target, where the data may be captured with a handheld scanning device (e.g., line scanner, mobile device, etc.). In some examples, 1D barcodes may be utilized on three-dimensional (3D) objects when a human can orient the object to align the barcode and a scanning device for capture. However, for automated scanning of 3D objects when the orientation of the object is not known or in cases where a human does not orient the object, some 1D barcodes may fail due to being out of the view of the scanning device.

One approach allows for more surface coverage by repeating the original barcode in original form at different locations on an item. That approach may provide better coverage than a single instance of the barcode but suffers from gaps on the surface of the item. Also, the size of some of the faces of the item may not accommodate the barcode in original form. Some approaches may allow a barcode to be wrapped around an item by utilizing a mapping to conform the barcode to a 3D surface of the item. Some approaches may utilize costly multi-directional capture hardware that scans items from multiple directions to detect the barcode. Some approaches may utilize a watermark that is repeated over a surface of a printed package for point-of-sale check out scanning. Those approaches may change the artwork on the packaging, resulting in a degradation of image quality.

Some of the techniques described herein may provide improved barcodes on 3D objects. For example, some of the techniques described herein may improve the readability of 1D barcodes. For instance, a 1D barcode on a 3D object may be produced that is readable from any direction to which the 1D barcode is exposed. Some examples may provide omnidirectional access for 1D barcodes, without utilizing a mapping that wraps the 1D barcode on the surface of the 3D object.

Some examples of the techniques described herein may provide a 1D barcode on a 3D object such that the 3D object is surrounded by the 1D barcode. In some examples, a set of volumes may be determined from a barcode. For example, the barcode may be projected or extended to determine the set of volumes. In some examples, the volumes may be trapezoidal, prismatic, polygonal, and/or rectangular. The set of volumes may intersect a 3D object. For example, the set of volumes may have a size and orientation to intersect the 3D object. Some examples of the techniques described herein may avoid wrapping a barcode onto an arbitrarily complex surface geometry. For example, some of the techniques described herein may not utilize the surface geometry of the 3D object to conform the barcode to the surface of the 3D object. Some of the techniques described herein may determine an intersection between a 3D object and volumes determined from the barcode. For example, the 3D object may be marked by changing a color of the 3D object at the intersection of the 3D object and the volumes. In some examples, the marking may be read and/or decoded by a scanning device (e.g., a line scanner) from any surrounding direction. Some examples of the techniques described herein may enable scanning without human intervention to orient the object.

Throughout the drawings, identical reference numbers may designate similar, but not necessarily identical, elements. Similar numbers may indicate similar elements. When an element is referred to without a reference number, this may refer to the element generally, without necessary limitation to any particular figure. The figures are not necessarily to scale, and the size of some parts may be exaggerated to more clearly illustrate the example shown. Moreover, the drawings provide examples and/or implementations in accordance with the description; however, the description is not limited to the examples and/or implementations provided in the drawings.

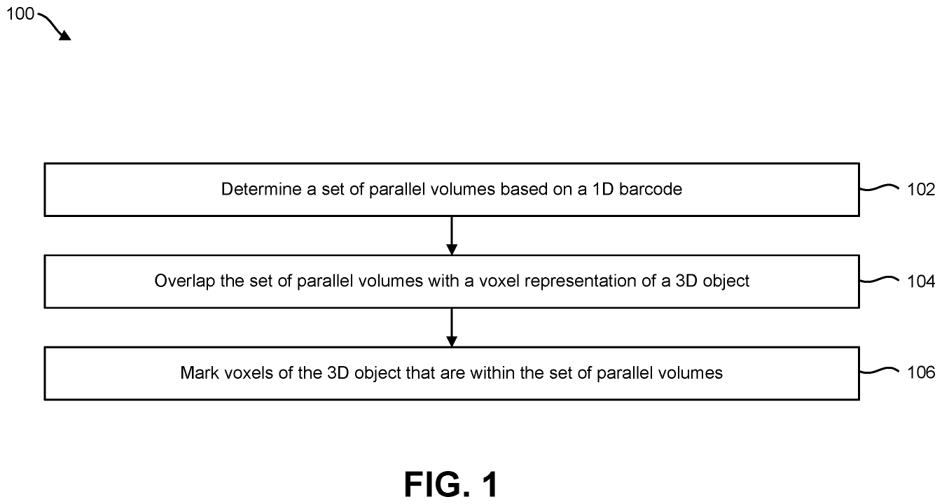

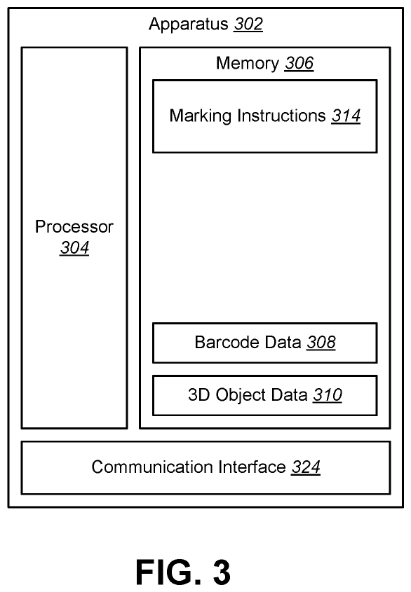

FIG. 1 is a flow diagram illustrating an example of a method 100 for 3D object marking. The method 100 and/or a method 100 element or elements may be performed by an apparatus (e.g., electronic device, computing device, server, 3D printer, etc.). For example, the method 100 may be performed by the apparatus 302 described in connection with FIG. 3.

The apparatus may determine 102 a set of parallel volumes based on a 1D barcode. The parallel volumes are regions of 3D space that are aligned to a same direction and/or that do not intersect. In some examples, the parallel volumes are extensions or projections of the 1D barcode into 3D space. A size along the dimension of the 1D barcode may be referred to as a span of the 1D barcode. Each bar of the 1D barcode may have a width along the dimension of the 1D barcode. Each pair of neighboring bars may have a distance between the bars. Each of the parallel volumes may have a volume width, a volume height, and a volume depth. In some examples, the parallel volumes may have uniform volume heights and/or uniform volume depths. In some examples, the parallel volumes may have non-uniform volume heights and/or non-uniform volume depths.

In some examples, determining 102 the set of parallel volumes may include determining a width for each of the parallel volumes. For instance, a volume width may be determined to be equal to a corresponding bar width for each of the bars. In some examples, a distance between the parallel volumes may be equal to a distance between corresponding bars.

In some examples, determining 102 the set of parallel volumes may include determining a height for the parallel volumes and/or for each parallel volume. The height of the parallel volumes (and/or a volume height of each volume) may be along a dimension that is perpendicular to the dimension of the 1D barcode. In some examples, the volume height for each of the volumes may be determined as equal to a corresponding bar height, determined in relation to a size of the 3D object, determined in relation to a build volume, determined according to a specified height (e.g., a predetermined height or a height indicated by a received input), or determined as unbounded. In some examples, a volume height may be determined based on a ratio (e.g., 0.5, 0.75, 1 or equal, 1.25, 1.5) in relation to a size (e.g., dimension) of the 3D object. In some examples, a volume height may be determined in relation to a build volume. A build volume is a volume in which the 3D object is manufactured. For instance, a volume height may be determined as bounded by the build volume.

In some examples, determining 102 the set of parallel volumes may include determining a depth for the parallel volumes and/or for each parallel volume. The depth of the parallel volumes (and/or a volume depth of each volume) may be along a dimension that is perpendicular to the dimension of the 1D barcode and/or to the height dimension of the volumes. In some examples, the volume depth for each of the volumes may be determined in relation to a size of the 3D object, determined in relation to a build volume, or determined as unbounded. In some examples, a volume depth may be determined based on a ratio (e.g., 0.5, 0.75, 1 or equal, 1.25, 1.5) in relation to a size (e.g., dimension) of the 3D object. In some examples, a volume depth may be determined in relation to a build volume. For instance, a volume depth may be determined as bounded by the build volume.

The apparatus may overlap 104 the set of parallel volumes with a voxel representation of a 3D object. A voxel is a region in a 3D space. For example, a voxel may represent a volume or component of a 3D space. For instance, a voxel may represent a volume that is a subset of the 3D space. In some examples, voxels may be arranged on a 3D grid. For instance, a voxel may be rectangular or cubic in shape. A voxel representation of a 3D object is a set of voxels that represent an object in three dimensions. For example, a voxel representation of a 3D object may include a set of voxels that correspond to the shape and/or region of a 3D object. In some examples, the voxel representation of the 3D object may be included in a set of voxels corresponding to a build volume. In some examples, the apparatus may overlap 104 the set of parallel volumes with the voxel representation of the 3D object by locating and/or orienting the set of parallel volumes to intersect with the voxel representation in 3D space. In some examples, the location and/or orientation may be based on an input received from a user. In some examples, the location and/or orientation may be automatically determined by the apparatus. For example, the apparatus may select a location and/or orientation of the parallel volumes where all of the parallel volumes overlap the voxel representation of the 3D object. In some examples, the set of parallel volumes may be positioned perpendicular to a printing axis (e.g., an x, y, or z printing axis). In some examples, printing axes may be a set of Cartesian axes with x, y, and z axes for printing. For example, the orientation of the parallel volumes may be determined such that a face of a volume is perpendicular to a printing axis (e.g., x, y, and/or z). Other orientations may be utilized in some examples.

In some examples, printing may include additive manufacturing and/or 3D printing. Examples of additive manufacturing may include fusion-based additive manufacturing, such as Multi Jet Fusion (MJF), Metal Jet Fusion, Selective Laser Melting (SLM), Selective Laser Sintering (SLS), liquid resin-based printing, etc. Stereolithography (SLA) and fused filament fabrication (FFF) (e.g., FFF with inkjetting of colors) are also examples of additive manufacturing.

The apparatus may mark 106 voxels of the 3D object that are within the set of parallel volumes. In some examples, marking 106 the voxels of the 3D object that are within the set of parallel volumes may include identifying voxels of the 3D object that are within spatial ranges of the parallel volumes. For example, the apparatus may determine voxels of the 3D object that are within a spatial range indicated by the volume width, volume height, and/or volume depth of each of the parallel volumes. In some examples, marking 106 the voxels may include modifying a file used to print the 3D object. For example, marking 106 the voxels may include modifying colors in the file at the locations of the identified voxels. Modifying the file may cause a printer to print different colors for the 3D object (e.g., for the volumes). In some examples, the file may be a computer-aided design (CAD) file and/or a file in a format used by a printer during printing. In some examples, the file may be modified to add the barcode by the printer or by another device that may provide the modified file for printing. Each of the voxels that is within the spatial range may be recorded and/or flagged. In some examples, marking 106 the voxels of the 3D object that are within the set of parallel volumes may include printing the 3D object. For instance, voxels of the 3D object (e.g., recorded and/or flagged voxels) that are within the set of parallel volumes may be printed with a first color (e.g., black or another color) that is different from a second color (e.g., white or another color) of a second set of voxels of the 3D object that are outside of the set of parallel volumes. In some examples, marking 106 the voxels of the 3D object may include printing a color change along one print dimension (e.g., along an x, y, or z printing axis), or along a direction in a 3D space. For instance, the apparatus may mark 106 the voxels by printing layers of the 3D object that are within the set of parallel volumes. In some examples, marking 106 the voxels of the 3D object may include printing a different material in the set of parallel volumes. For example, a different agent, material, or colorant may be printed for voxels within the parallel volumes than voxels outside of the parallel volumes. In some examples, marking 106 the voxels of the 3D object may produce a barcode that is readable from any direction to which the barcode is exposed. In some examples, an element or elements of the method 100 may be omitted or combined.

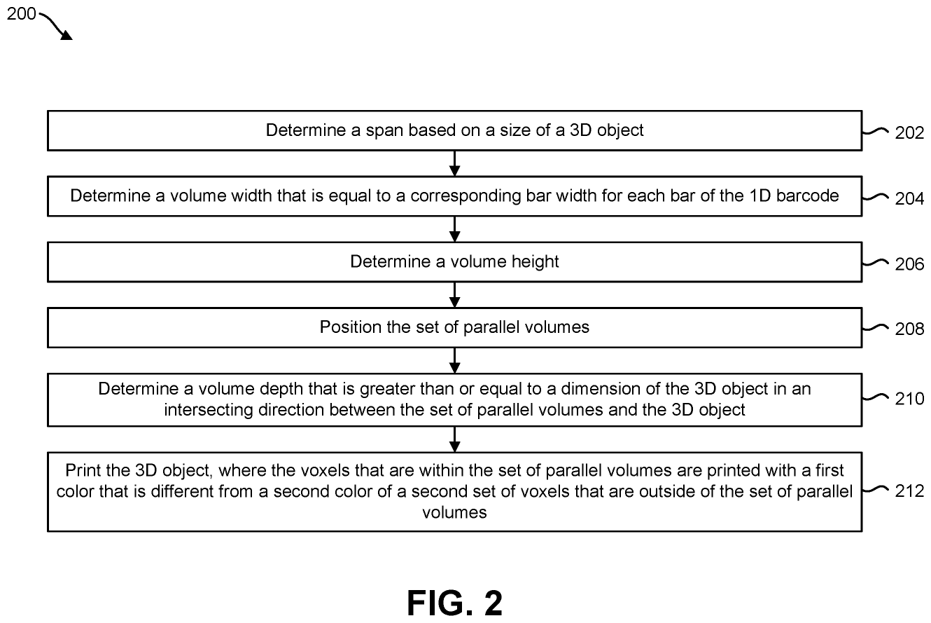

FIG. 2 is a flow diagram illustrating an example of a method 200 for 3D object marking. The method 200 may be an example of the method 100 described in connection with FIG. 1. The method 200 and/or a method 200 element or elements may be performed by an apparatus (e.g., electronic device, computing device, server, 3D printer, etc.). For example, the method 200 may be performed by the apparatus 302 described in connection with FIG. 3.

The apparatus may determine 202 a span of a set of parallel volumes based on a size of a 3D object. In some examples, the span may be determined 202 to be less than or equal to a size (e.g., dimension) of the 3D object. For instance, the span may be less than or equal to a size of the 3D object along the dimension of a 1D barcode. In some examples, the span may be determined 202 based on a ratio (e.g., 0.5, 0.75, 1 or equal, etc.) between a size (e.g., dimension) of the 3D object and the span.

The apparatus may determine 204 a volume width that is equal to a corresponding bar width for each bar of the 1D barcode. For instance, a volume width may be determined 204 to be equal to a corresponding bar width for each of the bars. The volumes may be included in a set of parallel volumes corresponding to the bars of the barcode.

The apparatus may determine 206 a volume height. In some examples, this may be accomplished as described in connection with FIG. 1. In some examples, the volume height for each of the volumes may be determined 206 based on received input (e.g., with a height specified by a received input), determined 206 as equal to a corresponding bar height, determined 206 in relation to a size of the 3D object, determined 206 in relation to a build volume, or determined 206 as unbounded. For instance, the volume height may be determined 206 as equal to a specified height (e.g., a predetermined height or a height specified by a received input). In some examples, the apparatus may determine 206 a volume height that is equal to a bar height for each bar of the 1D barcode. For example, the volume height for all of the volumes may be the height of a bar of the 1D barcode. For instance, all of the volumes may have the same height. Some bars of the 1D barcode may have different heights. In some examples, the height of some of the volumes may be greater or less then corresponding bar heights. In some examples, a volume height for each volume may be the height of a corresponding bar of the 1D barcode. In some examples, the volume height may be predetermined.

The apparatus may position 208 the set of parallel volumes. In some examples, positioning 208 the set of parallel volumes may include locating and/or orienting the set of parallel volumes such that the parallel volumes are perpendicular to a line (e.g., direction, axis, vector, etc.) in 3D space or parallel to a line (e.g., direction, axis, vector, etc.) in 3D space. For example, the set of parallel volumes may be positioned 208 (e.g., located and/or oriented) such that each of the parallel volumes is perpendicular to an x, y, or z printing axis.

The apparatus may determine 210 a volume depth that is greater than or equal to a dimension of the 3D object in an intersecting direction between the set of parallel volumes and the 3D object. For example, the apparatus may determine 210 a volume depth that is greater than or equal to a size of the 3D object along the depth direction or axis that intersects with the 3D object. In some examples, different volumes may have different depths corresponding to 3D object depths over the span of the 1D barcode.

The apparatus may print 212 the 3D object, where the voxels that are within the set of parallel volumes are printed with a first color that is different from a second color of a second set of voxels that are outside of the set of parallel volumes. For example, voxels of the 3D object within the intersection of the parallel volumes may be printed with a first color. Voxels of the 3D object that are outside of the intersection of the parallel volumes (e.g., between the parallel volumes) may be printed with a second color. In some examples, printing 212 the voxels of the 3D object may include printing a color change along one print dimension (e.g., along an x, y, or z printing axis). For instance, the apparatus may mark 106 the voxels by printing layers of the 3D object that are within the set of parallel volumes. In some examples, printing 212 the voxels of the 3D object may include printing a different material in the set of parallel volumes. For example, a different agent, material, or colorant may be printed for voxels within the parallel volumes than for voxels outside of the parallel volumes. In some examples, printing 212 the voxels of the 3D object may produce a barcode that is readable from any direction to which the barcode is exposed. In some examples, an element or elements of the method 200 may be omitted or combined.

FIG. 3 is a block diagram of an example of an apparatus 302 that may be used in 3D object marking. The apparatus 302 may be an electronic device, such as a personal computer, a server computer, a printer, a 3D printer, a smartphone, a tablet computer, etc. The apparatus 302 may include and/or may be coupled to a processor 304 and/or a memory 306. The apparatus 302 may include additional components (not shown) and/or some of the components described herein may be removed and/or modified without departing from the scope of this disclosure.

The processor 304 may be any of a central processing unit (CPU), a digital signal processor (DSP), a semiconductor-based microprocessor, graphics processing unit (GPU), field-programmable gate array (FPGA), an application-specific integrated circuit (ASIC), and/or other hardware device suitable for retrieval and execution of instructions stored in the memory 306. The processor 304 may fetch, decode, and/or execute instructions stored in the memory 306. In some examples, the processor 304 may include an electronic circuit or circuits that include electronic components for performing a function or functions of the instructions. In some examples, the processor 304 may be implemented to perform one, some, or all of the functions, operations, elements, methods, etc., described in connection with one, some, or all of FIGS. 1-6.

The memory 306 is an electronic, magnetic, optical, and/or other physical storage device that contains or stores electronic information (e.g., instructions and/or data). The memory 306 may be, for example, Random Access Memory (RAM), Electrically Erasable Programmable Read-Only Memory (EEPROM), a storage device, an optical disc, and/or the like. In some examples, the memory 306 may be volatile and/or non-volatile memory, such as Dynamic Random Access Memory (DRAM), EEPROM, magnetoresistive random-access memory (MRAM), phase change RAM (PCRAM), memristor, flash memory, and/or the like. In some implementations, the memory 306 may be a non-transitory tangible machine-readable storage medium, where the term “non-transitory” does not encompass transitory propagating signals. In some examples, the memory 306 may include multiple devices (e.g., a RAM card and a solid-state drive (SSD)).

In some examples, the apparatus 302 may include a communication interface 324 through which the processor 304 may communicate with an external device or devices (e.g., 3D printer). In some examples, the apparatus 302 may be in communication with (e.g., coupled to, have a communication link with) a 3D printer. In some examples, the apparatus 302 may be a 3D printer.

The communication interface 324 may include hardware and/or machine-readable instructions to enable the processor 304 to communicate with the external device or devices. The communication interface 324 may enable a wired and/or wireless connection to the external device or devices. In some examples, the communication interface 324 may include a network interface card and/or may also include hardware and/or machine-readable instructions to enable the processor 304 to communicate with various input and/or output devices. Examples of output devices include a printer, a 3D printer, a display, etc. Examples of input devices include a keyboard, a mouse, a touch screen, etc., through which a user may input instructions and/or data into the apparatus 302.

In some examples, the memory 306 of the apparatus 302 may store marking instructions 314, barcode data 308, and/or 3D object data 310. The barcode data 308 is data that indicates a barcode or barcodes. For example, the barcode data 308 may include image data that depicts a barcode or barcodes (e.g., 1D barcode(s) and/or 2D barcode(s)). In some examples, the barcode data 308 may include data that indicates bar dimensions corresponding to bars of a barcode or barcodes. For instance, the barcode data 308 may indicate a set of bar widths for bars of a 1D barcode.

The 3D object data 310 is data that indicates a 3D object or objects. For example, the 3D object data 310 may indicate geometry, shape, location, region, volume, etc., of a 3D object or objects. In some examples, the 3D object data 310 may indicate a set of voxels or sets of voxels corresponding to a 3D object or objects. For instance, a build volume may include voxels, where a subset of the voxels may correspond to a 3D object or objects, which may be indicated by the 3D object data 310.

The marking instructions 314 are instructions for marking a 3D object or objects with a barcode or barcodes. In some examples, the marking instructions 314 include executable code to determine a set of volumes arranged according to a 1D barcode. For instance, the processor 304 may execute the marking instructions 314 to determine a set of volumes arranged according to a 1D barcode. In some examples, the volumes may be trapezoidal, prismatic, polygonal, and/or rectangular. In some examples, determining the set of volumes may be accomplished as described in connection with FIG. 1 and/or FIG. 2. For instance, the processor 304 may determine volume width, volume height, and/or volume depth of a volume for each bar of a 1D barcode. In some examples, one face of each volume is the bar of the 1D barcode.

In some examples, the marking instructions 314 may include executable code to determine an intersection between the set of volumes and a 3D object. For instance, the processor 304 may execute the marking instructions 314 to determine an intersection between the set of volumes and the 3D object. In some examples, the processor 304 may determine the intersection by identifying voxels of the 3D object that are within a spatial range of the set of volumes. For instance, the processor 304 may determine whether a voxel of the 3D object is within a range in an x dimension of the volume, within a range in a y dimension of the volume, and within a range in a z dimension of the volume. In a case that the voxel of the 3D object is within the x, y, and z ranges of the volume, the voxel may be determined to be within the spatial range of the set of volumes (e.g., in the intersection between the set of volumes and the 3D object(s)). The determination may be performed for a set of voxels (e.g., all voxels of the 3D object(s), surface voxels of the 3D object(s), voxels in a build volume, etc.).

In some examples, the marking instructions 314 may include executable instructions to mark voxels of the 3D object in the intersection. For example, the processor 304 may execute the marking instructions 314 to mark voxels of the 3D object in the intersection. For instance, the processor 304 may mark voxels in the intersection with a color that is different from a color of voxels outside of the intersection.

In some examples, the processor 304 may mark the voxels (e.g., the voxels in the intersection) by blue clipping a color of the voxels. Blue clipping is a technique that inverse clips a blue component in a color space. For example, using a red-green-blue (RGB) color space, blue clipping may be utilized to set the color of the voxels in the intersection (e.g., barcode marks) by copying the red and green components of the 3D object, and inverse clipping the blue component. For instance, if the range of the blue component of the original color is 0≤Bo≤1, then the blue component Bb of the barcode color may be Bb=0 if Bo≥T or Bb=1 if Bo<T, where T is a threshold. For example, a blue clipped value of cyan (RGB=0,1,1) is green (RGB=0,1,0). Blue clipping may provide a color combination that is difficult for a human to see but that may be detected in by a scanning device in the blue channel.

In some examples, the marking instructions 314 may include executable code to print the 3D object with the marked voxels. For example, the processor 304 may execute the marking instructions 314 to print the 3D object and/or to send a command to a 3D printer to print the 3D object.

Some benefits of some examples of the techniques described herein are given as follows. In some examples, a 1D barcode may be three-dimensionalized to allow automated scanning devices (e.g., single-line scanners) to read the embedded information or data of a barcode on the 3D object without regard to orientation. Some examples of the techniques may accordingly eliminate human intervention for orienting the object relative to the scanning device. Some examples of the techniques described herein may provide omnidirectional barcodes on the surfaces of 3D printed objects, which may enable intervention-free tracking of the 3D printed objects. In some examples, the barcode may provide 360 degrees of readable data around a 3D object. In some examples, a variety of 1D barcodes (e.g., existing barcode designs) may be utilized to generate the set of volumes. In some examples, barcode coloring may be determined using blue clipping, which may reduce the visual impact of the barcode, preserve the aesthetics of the 3D object, and/or reduce the impact to the visual appearance (e.g., artwork) of the 3D object. Some examples of the techniques may not utilize knowledge of 3D surface geometry to determine the marking. Some examples of the techniques may enable scanning by a single fixed line scanner (rather than multiple scanners) to detect the mark. In some examples, an element or elements of the apparatus 302 may be omitted or combined.

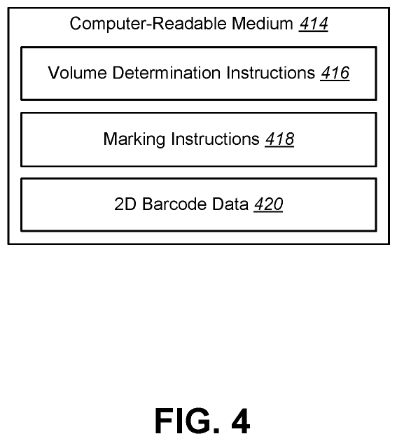

FIG. 4 is a block diagram illustrating an example of a computer-readable medium 414 for 3D object marking. The computer-readable medium is a non-transitory, tangible computer-readable medium 414. The computer-readable medium 414 may be, for example, RAM, EEPROM, a storage device, an optical disc, and the like. In some examples, the computer-readable medium 414 may be volatile and/or non-volatile memory, such as DRAM, EEPROM, MRAM, PCRAM, memristor, flash memory, and the like. In some implementations, the memory 306 described in connection with FIG. 3 may be an example of the computer-readable medium 414 described in connection with FIG. 4.

The computer-readable medium 414 may include code (e.g., data and/or instructions). For example, the computer-readable medium 414 may include volume determination instructions 416, marking instructions 418, and/or two-dimensional (2D) barcode data 420. The 2D barcode data 420 is data indicating a 2D barcode or barcodes. A 2D barcode is a barcode in which information or data is represented in two dimensions. For example, the height and width of marks in the 2D barcode and/or vertical and/or horizontal distances between marks in the 2D barcode may represent data and/or information.

The volume determination instructions 416 include code to cause a processor to determine a set of rectangular volumes corresponding to a 2D barcode. For example, the processor may determine a set of rectangular volumes where the volume widths are equal to the widths of the marks of the 2D barcode and where the volume heights are equal to the heights of the marks of the 2D barcode. The volume depths may be determined as described in connection with FIG. 1, FIG. 2, and/or FIG. 3.

In some examples, the volume determination instructions 416 may include code to cause a processor to determine an orientation of the set of rectangular volumes. For example, the processor may determine an orientation of the set of rectangular volumes such that a face of a rectangular volume is perpendicular to a printing axis (e.g., x, y, and/or z). Other orientations may be utilized in some examples.

The marking instructions 418 may include code to cause a processor to mark voxels of a 3D object that are within the set of rectangular volumes. This may be accomplished as described in connection with FIG. 1, FIG. 2, and/or FIG. 3.

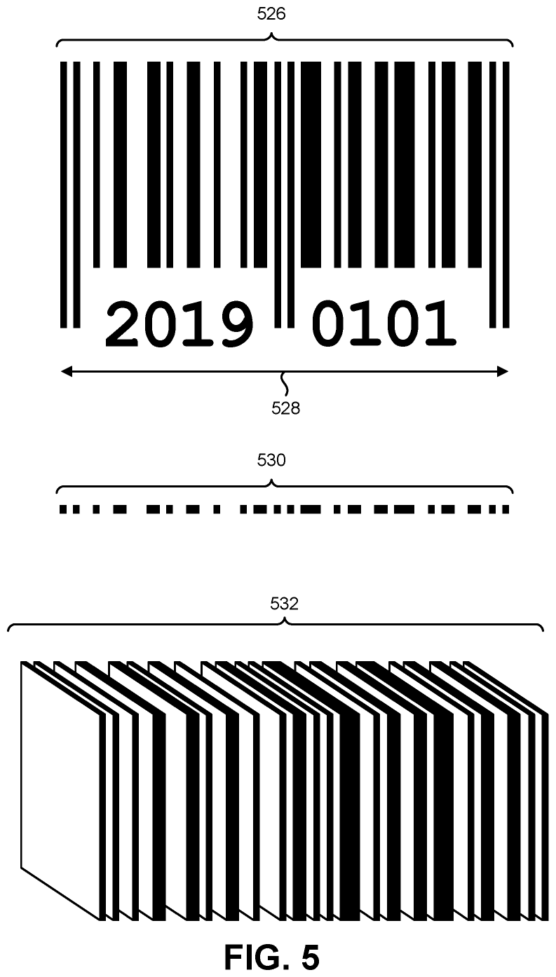

FIG. 5 is a diagram illustrating an example of a 1D barcode 526 and an example of a set of volumes 532 based on the 1D barcode 526 in accordance with some examples of the techniques described herein. In the example illustrated in FIG. 5, the 1D barcode 526 is an example of a Universal Purchasing Code (UPC-A) barcode. Other types of barcodes may be utilized in accordance with the techniques described herein. The information or data represented by the 1D barcode 526 may be indicated by the widths of bars and/or distances between bars along one dimension as illustrated in a 1D barcode visualization 530 shown in FIG. 5.

In some examples of the techniques described herein, the barcode 526 may be utilized to produce the set of volumes 532 in three dimensions. For instance, 3D volumes may be generated with volume widths that are equal to bar widths of the 1D barcode 526, where the volumes are separated by distances equal to distances between bars of the 1D barcode 526. Generating the volumes may produce the set of volumes 532 corresponding to the 1D barcode.

Some examples of the techniques described herein intersect the set of volumes 532 with a 3D object to be printed. The intersection of the set of volumes 532 with the 3D object may be printed in a color that can be distinguished from regions of the 3D object between volumes in the set of volumes 532 (e.g., from the rest of the 3D object). For example, the 3D object may be printed with a color change and/or material change at the location of the intersection.

The size of the span 528 of the 1D barcode 526 is illustrated in FIG. 5. In some examples, the span 528 may be determined based on the size of the 3D object and/or based on the size range that a scanning device is capable of detecting. For instance, the span 528 may be within a size range of the 3D object and may be within a barcode size range that is detectable by a scanning device (e.g., line scanner, camera, mobile device, etc.). In some examples, the total width of the set of volumes 532 may be equal to the span 528 or may be scaled (larger or smaller) relative to the span 528.

In some examples, the side faces of the set of volumes 532 may be perpendicular to a line (e.g., direction, axis, vector, etc.) in 3D space. For instance, the side faces may be perpendicular to the direction of the span 528 or to another line. In some examples, two dimensions of the side faces (e.g., planes) may be unbounded or may be other sizes (e.g., equal to the extent of the 3D object). In some examples, the side faces may not be perpendicular to a line (e.g., the direction of the span 528).

The orientation of the set of volumes 532 relative to the 3D object may be determined as described herein. For example, the orientation of the set of volumes 532 may be predetermined or may be determined based on the 3D object and/or based on a user input. The orientation of the set of volumes 532 may be any angle relative to the 3D object. In some examples, the set of volumes 532 may be oriented perpendicular to a line (e.g., direction, axis, vector, x axis, y axis, z axis, etc.) in 3D space. In some cases, the color change may occur along the line. The color change can be any color change that distinguishes between the volumes and regions between volumes to allow detection by a scanning device. In some examples, the color of the intersection may be determined by blue clipping.

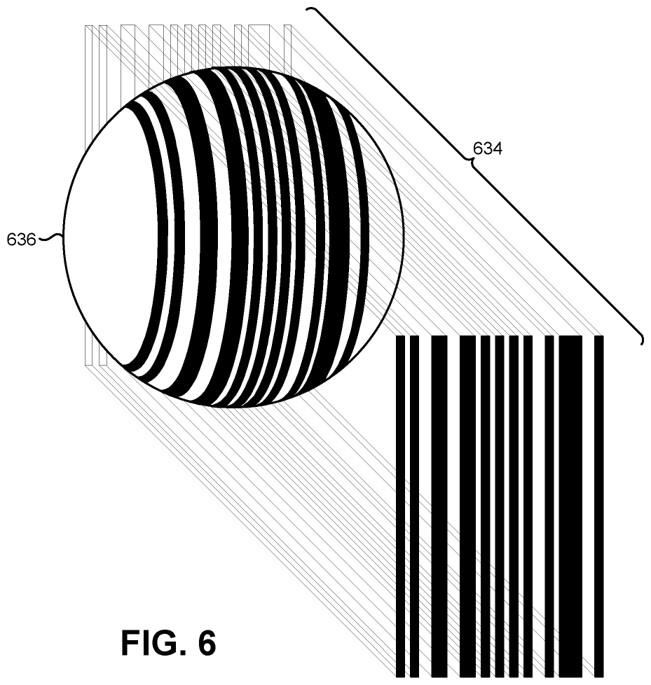

FIG. 6 is a diagram illustrating a set of volumes 634 and a 3D object 636. The set of volumes 634 may be an example of the sets of parallel volumes and/or of the sets of rectangular volumes described herein. In this example, the 3D object 636 has no planar surfaces. As illustrated in FIG. 6, the set of volumes 634 may be positioned to overlap with and/or intersect with the 3D object 636 (or a voxel representation of the 3D object 636). The voxels of the 3D object 636 that are within the set of volumes 634 (e.g., within each volume of the set of volumes 634) may be marked. In this example, the color of the 3D object 636 is white and the intersection of the set of volumes 634 is marked black, which may result in the printed 3D object 636 as illustrated. In this example, the set of volumes 634 is oriented along an x axis. The resulting barcode on the 3D object 636 may be read with a scanning device (e.g., line scanner, barcode reader, etc.).

While various examples of systems and methods are described herein, the systems and methods are not limited to the examples. Variations of the examples described herein may be implemented within the scope of the disclosure. For example, operations, functions, aspects, or elements of the examples described herein may be omitted or combined.

1. A method, comprising:
determining a set of parallel volumes based on a one-dimensional (1D) barcode;
overlapping the set of parallel volumes with a voxel representation of a three-dimensional (3D) object; and
marking voxels of the 3D object that are within the set of parallel volumes.

2. The method of claim 1, wherein determining the set of parallel volumes comprises determining a span of the set of parallel volumes based on a size of the 3D object.

3. The method of claim 1, wherein determining the set of parallel volumes comprises determining, for each bar of the 1D barcode, a volume width that is equal to a corresponding bar width.

4. The method of claim 1, wherein determining the set of parallel volumes comprises determining a volume height that is equal to a specified height.

5. The method of claim 1, wherein determining the set of parallel volumes comprising determining a volume depth that is greater than or equal to a dimension of the 3D object in an intersecting direction between the set of parallel volumes and the 3D object.

6. The method of claim 1, wherein marking the voxels of the 3D object comprises printing the 3D object.

7. The method of claim 6, wherein the voxels of the 3D object that are within the set of parallel volumes are printed with a first color that is different from a second color of a second set of voxels of the 3D object that are outside of the set of parallel volumes.

8. The method of claim 6, wherein the set of parallel volumes is positioned perpendicular to a line in a 3D space.

9. The method of claim 8, wherein marking the voxels of the 3D object comprises printing a different material in the set of parallel volumes.

10. The method of claim 1, wherein marking the voxels of the 3D object produces a barcode that is readable from any direction to which the barcode is exposed.

11. An apparatus, comprising:
a memory; and
a processor coupled to the memory, wherein the processor is to:
determine a set of volumes arranged according to a one-dimensional (1D) barcode;
determine an intersection between the set of volumes and a three-dimensional (3D) object; and
mark voxels of the 3D object in the intersection.

12. The apparatus of claim 11, wherein the processor is to determine the intersection by identifying voxels of the 3D object that are within a spatial range of the set of volumes.

13. The apparatus of claim 11, wherein the processor is to mark the voxels by blue clipping a color of the voxels.

14. A non-transitory tangible computer-readable medium storing executable code, comprising:
code to cause a processor to determine a set of rectangular volumes corresponding to a two-dimensional (2D) barcode; and
code to cause the processor to mark voxels of a three-dimensional (3D) object that are within the set of rectangular volumes.

15. The computer-readable medium of claim 14, further comprising code to cause the processor to determine an orientation of the set of rectangular volumes.
